(19) United States
(12) Patent Application Publication
(10) Pub. No.: US 2025/0310804 A1
(43) Pub. Date: Oct. 2, 2025

(54) PAYLOAD DESIGN FOR JOINT CHANNEL STATE INFORMATION (CSI) AND CROSS-LINK INTERFERENCE (CLI) REPORTING

(71) Applicant: QUALCOMM Incorporated, San Diego, CA (US)

(72) Inventors: Abdelrahman Mohamed Ahmed Mohamed IBRAHIM, San Diego, CA (US); Muhammad Sayed Khairy ABDELGHAFFAR, San Jose, CA (US); Ahmed Attia ABOTABL, San Diego, CA (US)

(21) Appl. No.: 18/620,581

(22) Filed: Mar. 28, 2024

(51) Int. Cl. H04W 24/10; H04B 17/345; H04W 72/21

(52) U.S. Cl. CPC H04W 24/10; H04B 17/345; H04W 72/21

(57) ABSTRACT

Certain aspects of the present disclosure provide a method for wireless communications at a user equipment (UE). The UE may receive a configuration for measurement and joint reporting of channel state information (CSI) and cross-link interference (CLI). The UE may measure the CLI caused by transmissions from one or more other UEs, in accordance with the configuration. The UE may transmit a report with a set of fields including one or more parts of CSI and CLI information including the measured CLI, in accordance with the configuration.

### BACKGROUND

### Field of the Disclosure

Aspects of the present disclosure relate to wireless communications, and more particularly, to techniques for defining new report payload designs for joint reporting of channel state information (CSI) and cross-link interference (CLI) information.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications at a user equipment (UE). The method includes receiving a configuration for measurement and joint reporting of channel state information (CSI) and cross-link interference (CLI); measuring the CLI caused by transmissions from one or more other UEs, in accordance with the configuration; and transmitting a first report with a first set of fields comprising one or more parts of CSI and CLI information comprising the measured CLI, in accordance with the configuration.

Other aspects provide: an apparatus operable, configured, or otherwise adapted to perform the aforementioned methods as well as those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station (BS) architecture.

FIG. 3 depicts aspects of an example BS and an example user equipment (UE).

FIG. 4A, FIG. 4B, FIG. 4C, and FIG. 4D depict various example aspects of data structures for a wireless communications network.

FIG. 5, FIG. 6, FIG. 7, and FIG. 8 depict different use cases for full-duplex (FD) communications.

FIG. 9 and FIG. 10 depict example in-band full duplex (IBFD) scheme.

FIG. 11 depicts example FD operation at a gNodeB (gNB).

FIG. 12A and FIG. 12B depict example sub-band full duplex (SBFD) slots.

FIG. 13 depicts example sub-band frequency division duplex (FDD).

FIG. 14, FIG. 15, FIG. 16, and FIG. 17 depict example channel state information (CSI) reports including CSI fields for CSI.

FIG. 18 depicts example communications between FD gNB and half-duplex (HD) UEs.

FIG. 19 depicts example communications between FD gNB and FD UEs.

FIG. 20 depicts example communications between FD gNB and SBFD UE.

FIG. 21 depicts example layer 1 (L1) cross-link interference (CLI) framework.

FIG. 22 depicts a call flow diagram illustrating example communication among different wireless nodes for managing

FIG. 23 depicts a method for wireless communications at a wireless node such as a UE.

FIG. 24 depicts example communications device.

### DETAILED DESCRIPTION

Aspects of the present disclosure provide apparatuses, methods, processing systems, and computer-readable mediums for defining new channel state information (CSI) report payload designs for joint reporting of CSI and cross-link interference (CLI) information.

CSI generally refers to feedback that indicates how good or bad a channel is at a specific time. The CSI may include information such as a channel quality information (CQI), a precoding matrix indicator (PMI), and a rank indicator (RI). A user equipment (UE) measures and sends the CSI (e.g., in a CSI report) to a gNodeB (gNB) via a physical uplink control channel (PUCCH) or a physical uplink shared channel (PUSCH). The CSI report may include multiple CSI fields for conveying the CQI, the PMI, and the RI. Upon receiving and processing the CSI, the gNB may schedule one or more downlink data transmissions for the UE (e.g., with transmission parameters optimized based on the CSI).

In the context of wireless communications, communication interference may result in degradation of signals and signal quality. Signal interference is especially relevant to 5^{th} generation (5G) communications, including 5G new radio communications. One such form of interference is known as CLI. The CLI may occur between two gNBs and/or may occur between two UEs. For example, the CLI may refer to an interference with a downlink reception at the UE (e.g., in a first cell) due to an uplink transmission by another UE (e.g., in a second cell). The CLI may occur, for example, where a downlink resource of the first cell at least partially overlaps in a time-domain with an uplink resource of the second cell, and where both UEs may be located at the cell edge of the respective cells. The UE may be configured to measure and report the CLI so that results of measurement of the CLI may be used to adjust a transmit power of the other UE to reduce, mitigate, and/or eliminate the CLI with the downlink reception of the UE.

It may be beneficial for the gNB to know an impact of the CLI on the reported CSI. Accordingly, the UE may have a preference to send the CSI and the CLI information to the gNB at a same time and in a same report. The UE can use an existing CSI report framework to report the CLI information. For example, the UE can include the CLI information in the CSI report, so that both the CSI and the CLI information can be sent to the gNB in the same report. However, in certain cases, a payload size of the CSI report may be limited (e.g., especially when the CSI report has to be transmitted via the PUCCH), and in such cases the UE may not able to include the CLI information in the CSI report.

Techniques described herein provide multiple CSI report payload designs that may allow the joint reporting of the CLI information and the CSI in a same report. The multiple new CSI report payload designs may include at least a first CSI report payload design and a second CSI report payload design.

The first CSI report payload design may be used for the joint reporting of the CLI information and the CSI in the same report that is transmitted via a PUCCH. The first CSI report payload design is based on a modification of an existing payload design of a legacy CSI report including legacy CSI fields. In one example, the modification may include elimination of one or more legacy CSI fields and addition of one or more CLI fields for the CLI information. In another example, the modification may include reducing a size of the one or more legacy CSI fields and addition of the one or more CLI fields for the CLI information.

The second CSI report payload design may be used for the joint reporting of the CLI information and the CSI in the same report that is transmitted via a PUSCH. The second CSI report payload design may also be based on the modification of the existing payload design of the legacy CSI report including the legacy CSI fields. For example, the modification may include addition of the one or more CLI fields for the CLI information in the legacy CSI report.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

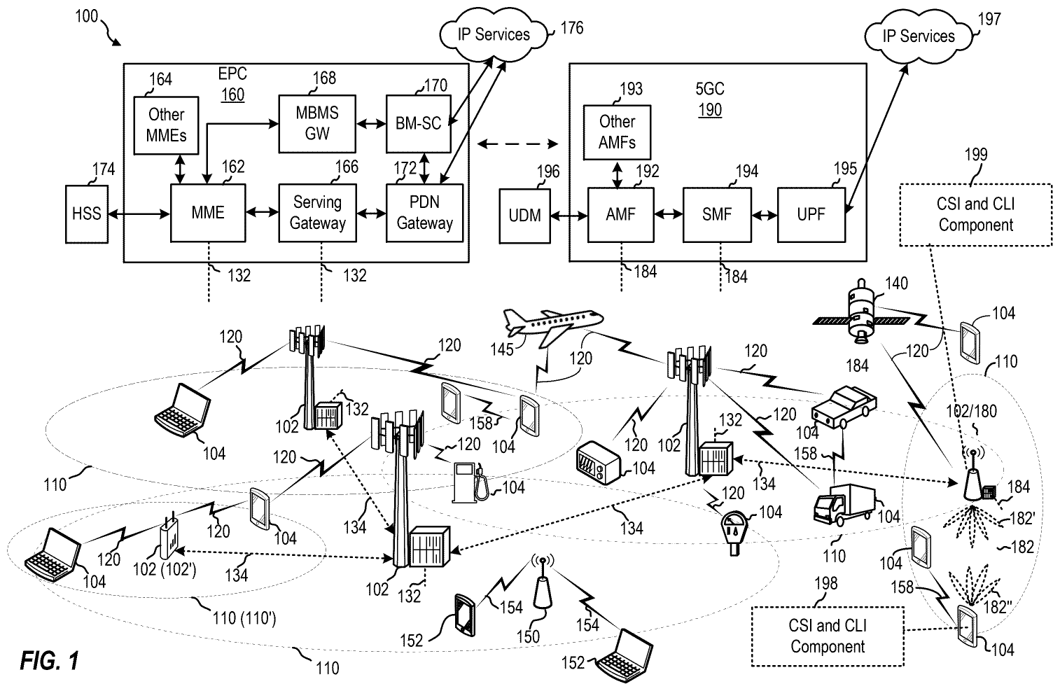

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio BS, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

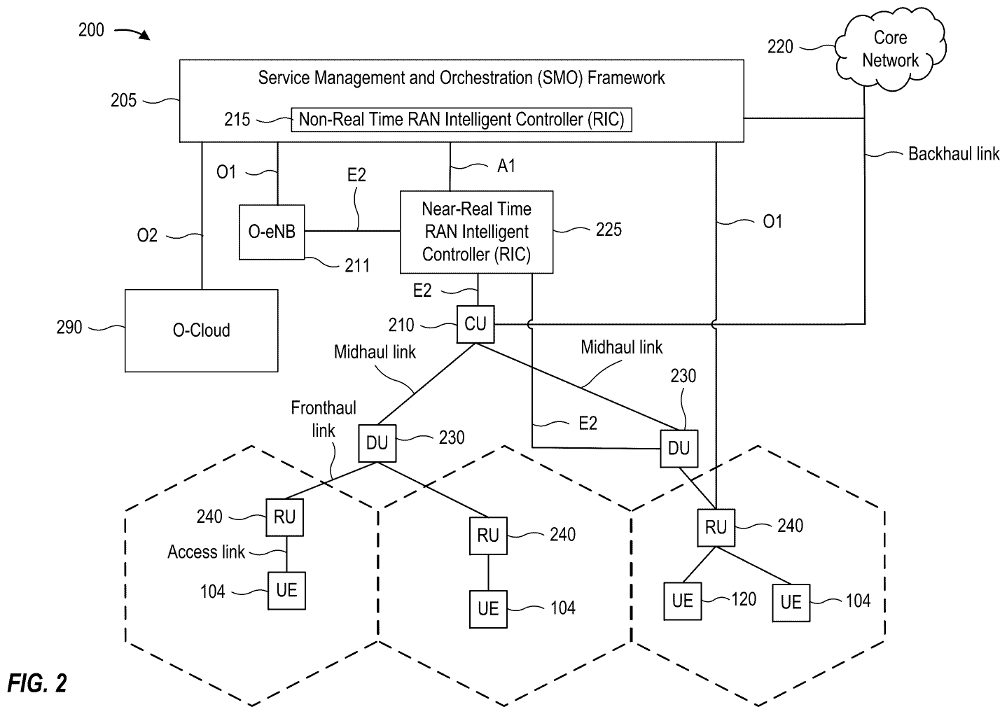

While BSs 102 are depicted in various aspects as unitary communications devices, BSs 102 may be implemented in various configurations. For example, one or more components of a BS 102 may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a BS 102 may be virtualized. More generally, a BS (e.g., BS 102) may include components that are located at a single physical location or components located at various physical locations. In examples in which a BS 102 includes components that are located at various physical locations, the various components may each perform functions such that, collectively, the various components achieve functionality that is similar to a BS 102 that is located at a single physical location. In some aspects, a BS 102 including components that are located at various physical locations may be referred to as a disaggregated radio access network (RAN) architecture, such as an Open RAN (O-RAN) or Virtualized RAN (VRAN) architecture. FIG. 2 depicts and describes an example disaggregated BS architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 600 MHz-6 GHz, which is often referred to (interchangeably) as “Sub-6 GHz”. Similarly, 3GPP currently defines Frequency Range 2 (FR2) as including 26-41 GHz, which is sometimes referred to (interchangeably) as a “millimeter wave” (“mmW” or “mmWave”). A BS configured to communicate using mmWave/near mmWave radio frequency bands (e.g., a mmWave BS such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain BSs (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

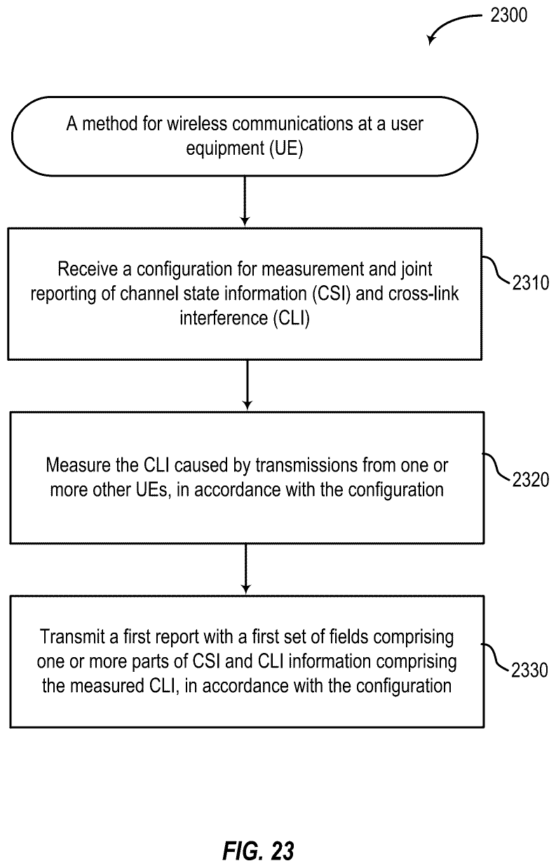

Wireless communication network 100 further includes channel state information (CSI) and cross-link interference (CLI) component 198, which may be configured to perform method 2300 of FIG. 23. Wireless communication network 100 further includes CSI and CLI component 199, which may be configured to perform method 2300 of FIG. 23.

In various aspects, a network entity or network node can be implemented as an aggregated BS, as a disaggregated BS, a component of a BS, an integrated access and backhaul (IAB) node, a relay node, a sidelink node, to name a few examples.

FIG. 2 depicts an example disaggregated BS 200 architecture. The disaggregated BS 200 architecture may include one or more central units (CUs) 210 that can communicate directly with a core network 220 via a backhaul link, or indirectly with the core network 220 through one or more disaggregated BS units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 245, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more BS functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd}Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

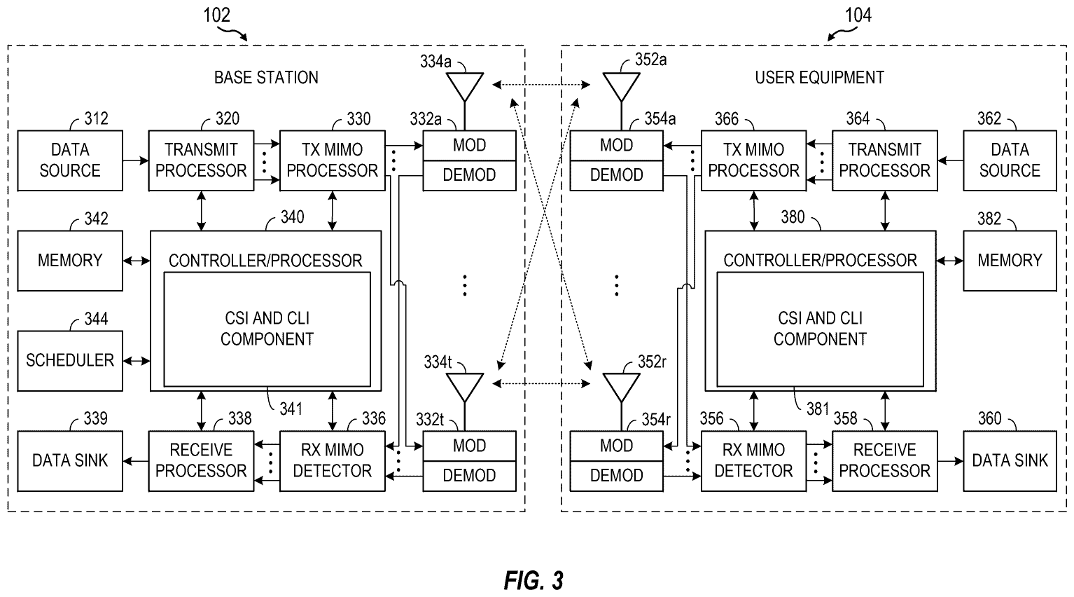

FIG. 3 depicts aspects of an example BS 102 and a UE 104.

Generally, BS 102 includes various processors (e.g., 324, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

BS 102 includes controller/processor 340, which may be configured to implement various functions related to wireless communications. In the depicted example, controller/processor 340 includes CSI and CLI component 341, which may be representative of CSI and CLI component 199 of FIG. 1. Notably, while depicted as an aspect of controller/processor 340, CSI and CLI component 341 may be implemented additionally or alternatively in various other aspects of BS 102 in other implementations.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

UE 104 includes controller/processor 380, which may be configured to implement various functions related to wireless communications. In the depicted example, controller/processor 380 includes CSI and CLI component 381, which may be representative of CSI and CLI component 138 of FIG. 1. Notably, while depicted as an aspect of controller/processor 380, CSI and CLI component 381 may be implemented additionally or alternatively in various other aspects of UE 104 in other implementations.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the SRS). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs 104 for data transmission on the downlink and/or uplink.

In various aspects, BS 102 may be described as transmitting and receiving various types of data associated with the methods described herein. In these contexts, “transmitting” may refer to various mechanisms of providing or outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

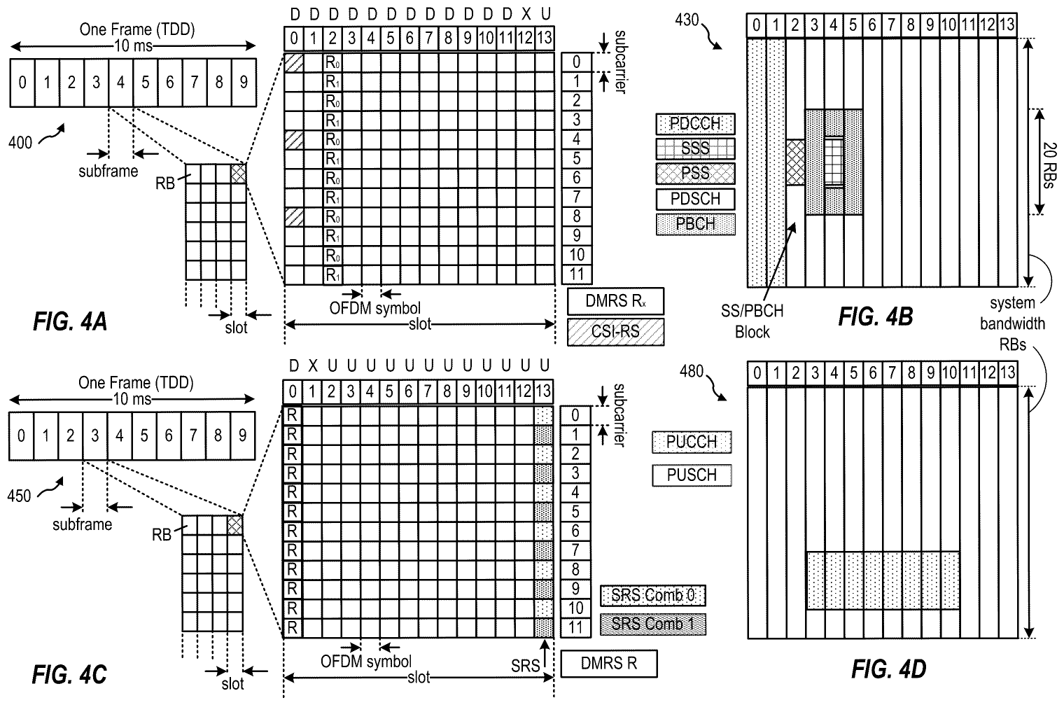

FIG. 4A, FIG. 4B, FIG. 4C, and FIG. 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIG. 4B and FIG. 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be TDD, in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs 104 may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2×15 kHz, where is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIG. 4A, FIG. 4B, FIG. 4C, and FIG. 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 s.

As depicted in FIG. 4A, FIG. 4B, FIG. 4C, and FIG. 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIG. 1 and FIG. 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIG. 1 and FIG. 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the BS. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a BS for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Introduction to mmWave Wireless Communications

In wireless communications, an electromagnetic spectrum is often subdivided into various classes, bands, channels, or other features. The subdivision is often provided based on wavelength and frequency, where frequency may also be referred to as a carrier, a subcarrier, a frequency channel, a tone, or a subband.

5^{th} generation (5G) networks may utilize several frequency ranges, which in some cases are defined by a standard, such as 3^{rd} generation partnership project (3GPP) standards. For example, 3GPP technical standard TS 38.101 currently defines Frequency Range 1 (FR1) as including 600 MHz-6 GHz, though specific uplink and downlink allocations may fall outside of this general range. Thus, FR1 is often referred to (interchangeably) as a “Sub-6 GHz” band.

Similarly, TS 38.101 currently defines Frequency Range 2 (FR2) as including 26-41 GHz, though again specific uplink and downlink allocations may fall outside of this general range. FR2, is sometimes referred to (interchangeably) as a “millimeter wave” (“mmW” or “mmWave”) band, despite being different from the extremely high frequency (EHF) band (30 GHz-300 GHz) that is identified by the International Telecommunications Union (ITU) as a “millimeter wave” band because wavelengths at these frequencies are between 1 millimeter and 10 millimeters.

Communications using mmWave/near mmWave radio frequency band (e.g., 3 GHz-300 GHz) may have higher path loss and a shorter range compared to lower frequency communications. As described above with respect to FIG. 1, a base station (BS) (e.g., 180) configured to communicate using mmWave/near mmWave radio frequency bands may utilize beamforming (e.g., 182) with a user equipment (UE) (e.g., 104) to improve path loss and range.

### Overview of Multiple-Input Multiple-Output (MIMO) System

Multiple-input multiple-output (MIMO) is a multi-antenna technology that exploits multipath signal propagation so that information-carrying capacity of a wireless link can be multiplied by using multiple antennas at a transmitter node and a receiver node to send multiple simultaneous streams. At a multi-antenna transmitter node, a precoding technique (e.g., scaling the respective streams' amplitude and phase) is applied (e.g., based on known channel state information (CSI)). At a multi-antenna receiver node, the different spatial signatures of the respective streams (e.g., known CSI) can enable the separation of these streams from one another.

For example, a network entity (e.g., a gNodeB (gNB)) may include multiple antennas supporting MIMO technology. The use of MIMO technology enables the network entity to exploit spatial domain to support spatial multiplexing, beamforming, and transmit diversity. The spatial multiplexing may be used to transmit different streams of data simultaneously on a same frequency. The data steams may be transmitted to a single user equipment (UE) to increase a data rate or to multiple UEs to increase overall system capacity. This is achieved by spatially precoding each data stream (i.e., applying a scaling of an amplitude and a phase) and then transmitting each spatially precoded stream through multiple transmit antennas on a downlink. The spatially precoded data streams arrive at the UEs with different spatial signatures, which enables each of the UEs to recover the one or more data streams destined for that UE. On uplink, each UE transmits a spatially precoded data stream, which enables the network entity to identify the source of each spatially precoded data stream.

The performance of a MIMO system is related to a received signal-to-interference-and-noise ratio (SINR) and correlation properties of a multipath channel and antenna configuration. Using precoding techniques, the MIMO system can increase and/or equalize the received SINR across the multiple receive antennas. The transmitter node can utilize a plurality of complex weighting precoding matrices to precode the streams of a MIMO channel. The precoding matrices can be defined in a codebook where each precoding matrix can be identified by a precoding matrix index (PMI). When the codebook is known to both the transmitter node and the receiver node, the receiver node can inform the transmitter node to use a certain precoding matrix by sending the PMI of the desired precoding matrix to the transmitter node.

In new radio (NR) uplink, a UE can support up to 32 transmit (Tx) antennas, while the gNB can support up to 1024 receive (Rx) antennas. So, fine beamforming can be implemented on both the UE-Tx end and the BS-Rx end. With the significant increase in a number of antennas, an uplink MIMO gain of NR is much greater, including beamforming gain and multiplexing gain. However, since the achievable gain also depends on the design of the transmission technology, a closed loop-MIMO may be a preferred choice in the transmission scheme for uplink data channels. When an open-loop MIMO is used in uplink transmissions, benefits of increasing the number of antennas are limited. A semi-open-loop MIMO may be used in scenarios where accurate CSI cannot be obtained, such as UE movement, rotation, and partial channel reciprocity. In some cases, the open loop MIMO may allow the UE to report a rank indicator (RI) and channel quality indicator (CQI), while the closed loop MIMO may allow the UE to report RI, CQI and PMI.

MU-MIMO stands for multi-user, multiple input, multiple output, and represents a significant advance over single-user MIMO (SU-MIMO), which is generally referred to as MIMO. MU-MIMO is a set of MIMO technologies for multipath wireless communication, in which multiple users or terminals, each radioing over one or more antennas, communicate with one another. In contrast, SU-MIMO involves a single multi-antenna-equipped user or terminal communicating with precisely one other similarly equipped node.

### Overview of Transmission Modes

Full-duplex (FD) allows for simultaneous transmission between nodes (e.g., a user equipment (UE) and a base station (BS)). In a half-duplex (HD) system, communication flows in one direction at a time.

There are various motivations for utilizing FD communications, for example, for simultaneous uplink (UL)/downlink (DL) transmissions in Frequency Range 2 (FR2). In some cases, FD capability may enable flexible time division duplexing (TDD) capability, and may be present at either a base station (BS) or a UE or both. For example, at the UE, UL transmissions may be sent from one antenna panel (e.g., of multiple antenna panels) and DL receptions may be performed at another antenna panel. In another example, at a gNodeB (gNB), the UL transmissions may be from one panel and the DL receptions may be performed at another panel.

The FD capability may be conditional on a beam separation (e.g., self-interference between DL and UL, clutter echo, etc.). The FD capability may mean that the UE or the gNB is able to use frequency division multiplexing (FDM) or spatial division multiplexing (SDM) on slots conventionally reserved for UL only or DL only slots (or flexible slots that may be dynamically indicated as either UL or DL).

The potential benefits of the FD communications include latency reduction (e.g., it may be possible to receive DL signals in what would be considered UL only slots, which can enable latency savings), coverage enhancement, spectrum efficiency enhancements (per cell and/or per UE), and/or overall more efficient resource utilization.

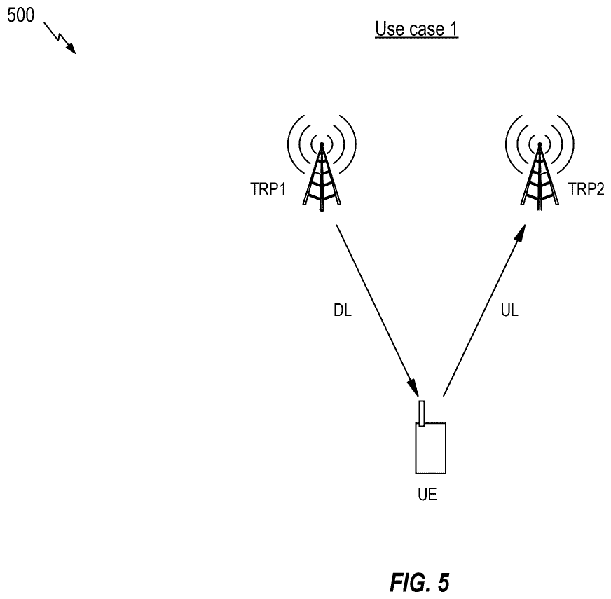

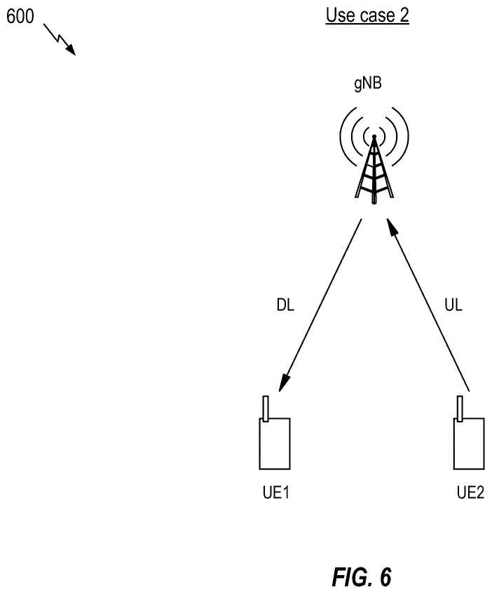

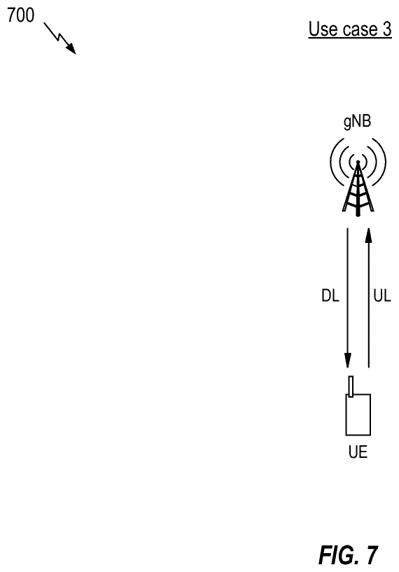

FIG. 5, FIG. 6, and FIG. 7 illustrate example use cases for FD communications. FIG. 8 summarizes certain possible features of these use cases.

Diagram 500 of FIG. 5 illustrates a first use case (e.g., Use Case 1) for FD communications. As illustrated, one UE simultaneously communicates with a first transmitter receiver point (TRP 1) on DL, while transmitting to a second TRP on UL. For this use case, FD is disabled at a gNB (i.e., TRP 1, TRP 2) and enabled at the UE.

Diagram 600 of FIG. 6 illustrates a second use case (e.g., Use Case 2) for FD communications. As illustrated, one gNB simultaneously communicates with a first UE (UE 1) on DL, while communicating with a second UE (UE 2) on UL. For this use case, FD is enabled at the gNB and disabled at the UEs. Use cases with the FD enabled at the gNB and disabled at the UEs may be suitable for integrated access and backhaul (IAB) applications as well (e.g., as illustrated in a table 800 of FIG. 8).

Diagram 700 of FIG. 7 illustrates a third use case (e.g., Use Case 3) for FD communications. As illustrated, a UE simultaneously communicates with a gNB, transmitting on UL while receiving on DL. For this use case, FD is enabled at both the gNB and the UE.

### Overview of In-Band Full Duplex (IBFD)

In-band full-duplex (IBFD) wireless technology allows a wireless device (e.g., a user equipment (UE)) to transmit and receive simultaneously in a same frequency band (e.g., same time and frequency resources), and thereby increasing a throughput of wireless communication systems and networks.

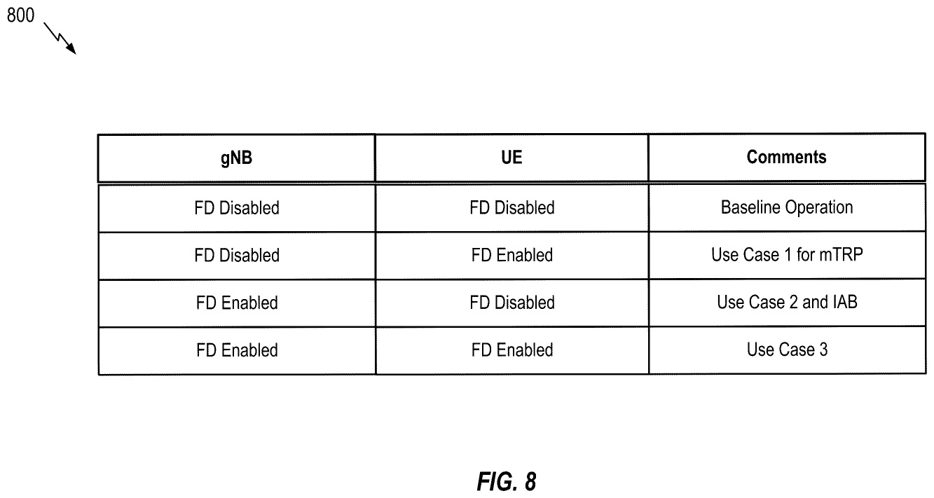

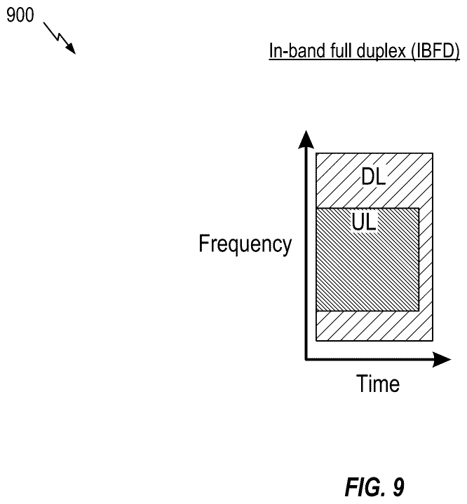

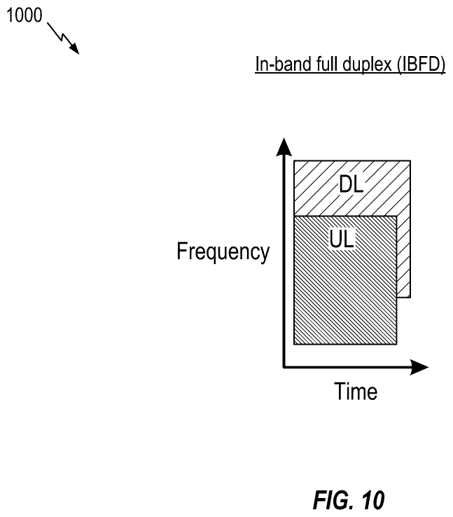

Downlink (DL) and uplink (UL) transmissions may share same IBFD time/frequency resources (e.g., full/partial overlap of the time/frequency resources). FIG. 9 depicts a diagram 900 showing a full overlap of the time/frequency resources for the DL and UL transmissions. FIG. 10 depicts a diagram 1000 showing a partial overlap of the time/frequency resources for the DL and UL transmissions.

### Overview of Sub-band Full Duplex (SBFD)

As compared to older communication standards, spectrum options for 5G new radio (NR) are considerably expanded. For example, a frequency range 2 (FR2) band extends from approximately 24 GHz to 60 GHz. Since the wavelength decreases as the frequency increases, the FR2 band is denoted as a millimeter wave band due to its relatively-small wavelengths. In light of this relatively short wavelength, the transmitted radio frequency (RF) signals in the FR2 band behave somewhat like visible light. Thus, just like light, millimeter-wave signals are readily shadowed by buildings and other obstacles. In addition, the received power per unit area of antenna element goes down as the frequency goes up. For example, a patch antenna element is typically a fraction of the operating wavelength (e.g., one-half of the wavelength) in width and length. As the wavelength goes down (and thus the size of the antenna element decreases), it may thus be seen that the signal energy received at the corresponding antenna element decreases. Millimeter-wave cellular networks will generally require a relatively-large number of base stations (BSs) due to the issues of shadowing and decreased received signal strength. A cellular provider must typically rent the real estate for the BSs such that widespread coverage for a millimeter-wave cellular network may become very costly.

As compared to the challenges of FR2, the electromagnetic properties of radio wave propagation in the sub-6 GHz bands are more accommodating. For example, the 5G NR frequency range 1 (FR1) band extends from approximately 0.4 GHz to 7 GHz. At these lower frequencies, the transmitted RF signals tend to refract around obstacles such as buildings so that the issues of shadowing are reduced. In addition, the larger size for each antenna element means that a FR1 antenna element intercepts more signal energy as compared to an FR2 antenna element. Thus, just as was established for older networks, a 5G NR cellular network operating in the FR1 band will not require an inordinate amount of BSs. Given the favorable properties of the lower frequency bands, the sub-6 GHz bands are often denoted as “beachfront” bands due to their desirability.

One issue with operation in the sub-6 GHz bands is that there is only so much bandwidth available. For this reason, Federal Communications Commission regulates the airwaves and conducts auctions for the limited bandwidth in the FR1 band. Given this limited bandwidth, it is challenging for a cellular provider to enable the high data rates that would be more readily achieved in the FR2 band. To meet these challenges, a “sub-band full duplex” (SBFD) network architecture is implemented, which is quite advantageous as it offers users the high data rates that would otherwise require usage of the FR2 band. The SBFD network architecture described herein provides the high data rates in the FR1 band, and thus lowers costs due to the smaller number of BSs per given area of coverage that may be achieved in the FR1 band as compared to the FR2 band.

Typically, each one millisecond (ms) sub frame may consist of one or multiple adjacent slots. For example, one sub frame includes four slots. In a four-slot structure, first two slots may be downlink (DL) slots whereas a final one of the fours slots is an uplink (UL) slot. The third slot is a special slot in which some symbols may be used for UL transmissions and others for DL transmissions. The resulting UL and DL traffic is thus time division duplexed (TDD) as arranged by the dedicated slots and as arranged by the symbol assignment in the special slot. Since the UL has only a single dedicated slot, UL communication may suffer from excessive latency since a user equipment (UE) is restricted to transmitting in the single dedicated UL slot and in the resource allocations within the special slot. Since there is only one dedicated UL slot in the repeating four-slot structure, the resulting latency can be problematic particularly for low-latency applications such as vehicle-to-vehicle communication. In addition, the energy for the UL communication is limited by its single dedicated slot.

To reduce uplink latency and increase the energy for the UL transmissions, SBFD mode may be implemented. The SBFD mode is a duplex mode with a TDD carrier split into sub-bands to enable simultaneous transmission and reception in same slots. For example, in the SBFD mode, some slots are modified as SBFD slots to support frequency duplexing for simultaneous UL and DL transmissions. Some slots may remain as legacy TDD slots where one slot is still dedicated to DL and another slot dedicated to UL. In one example four-slot structure, in the SBFD mode, the second and third slots may be SBFD slots modified to support frequency duplexing for simultaneous UL and DL transmissions. The first slot and the fourth slot may remain as legacy TDD slots such that the first slot is still dedicated to DL and the fourth slot dedicated to UL. In other examples, any slot may be used in the SBFD mode.

In the sub-6 GHz spectrum, the relatively-limited separation between antennas on a device will lead to substantial self-interference should the device engage in a simultaneous UL and DL transmission. In some cases, the frequency duplexing in the SBFD slots may be practiced by a BS transceiver.

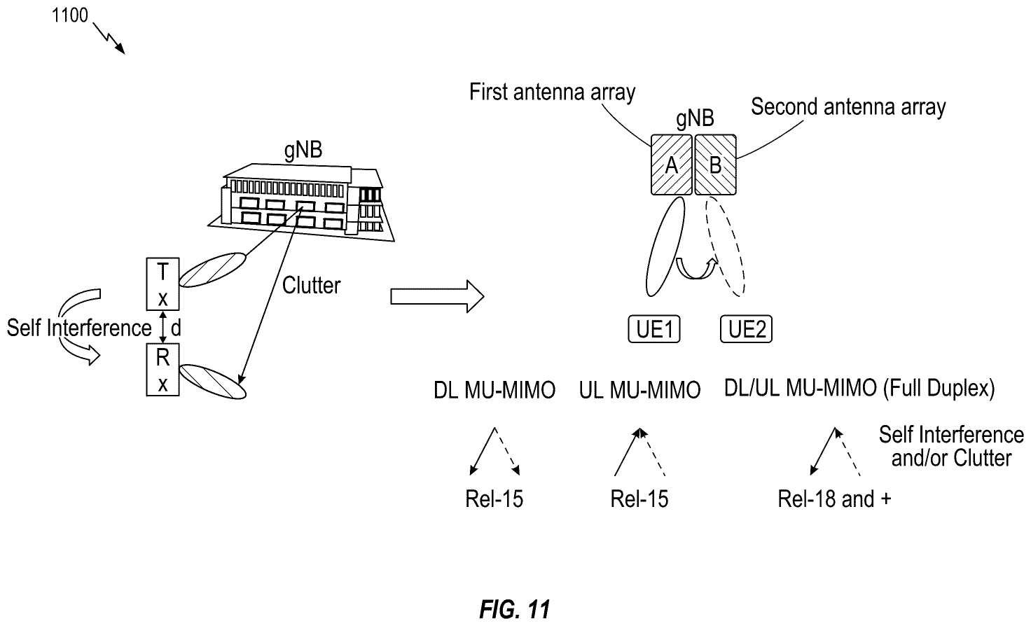

For example, a diagram 1100 of FIG. 11 depicts full-duplex (FD) operation at a gNodeB (gNB). An antenna system for the gNB is subdivided into a first antenna array that is separated from a second antenna array by an insulating distance such as, for example, 10 to 30 cm. During the SBFD operation, one of the antenna arrays transmits (e.g., to a first UE (UE1)) while the other antenna array is receiving (e.g., from a second UE (UE2)). The self-interference problem is partially addressed by a physical separation between the antenna arrays of the gNB. To provide additional isolation, a conducting shield between the antenna arrays of the gNB may also be implemented. It will be appreciated, however, that frequency duplexing may also be practiced by the device (or more generally, a UE) should the device practice sufficient self-interference cancellation. In other cases, however, the UE may be limited to half-duplex (HD) transmission such that the UE's antenna array is entirely dedicated to just transmitting or to just receiving in respective slots.

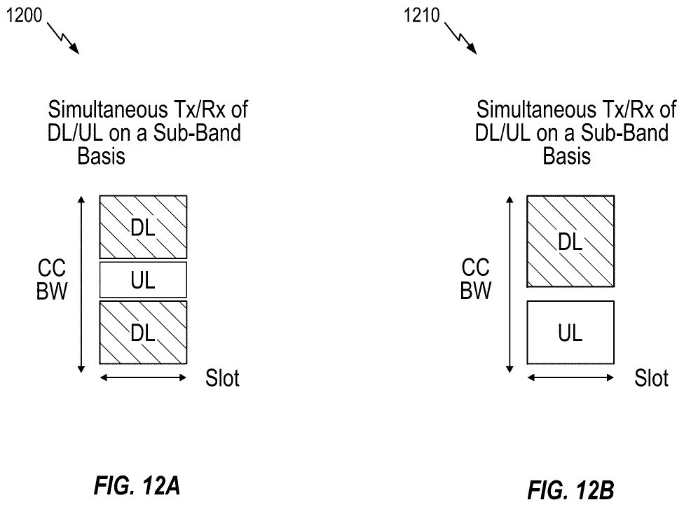

Example SBFD slots are depicted in FIG. 12A and FIG. 12B. For example, FIG. 12A depicts one SBFD slot 1200 and FIG. 12B depicts one SBFD slot 1210. Note that neither UL nor DL in the SBFD slots 1200, 1210 may occupy an entire frequency resource range (e.g., a frequency band) for these SBFD slots.

As depicted in FIG. 12A, the UL occupies a central sub-band in the frequency band for the SBFD slot 1200. The DL occupies a lower sub-band that ranges from a lower frequency for the frequency band up to a lowest frequency for the UL central sub-band. The DL also occupies an upper sub-band in the frequency band and extends from a greatest frequency for the UL central sub-band to a greatest frequency for the frequency band. In one example, the UL central sub-band may be symmetric about a center frequency for the SBFD slot 1200. In such example, the bandwidth for the DL lower sub-band and the DL upper sub-band would be equal. However, in other examples, the DL lower sub-band bandwidth may be different from the bandwidth for the DL upper sub-band. In some examples, the DL upper and lower sub-bands may each have the bandwidth that may vary as 10 MHz, 20 MHz, 30 MHz or 40 MHz depending upon a DL data rate.

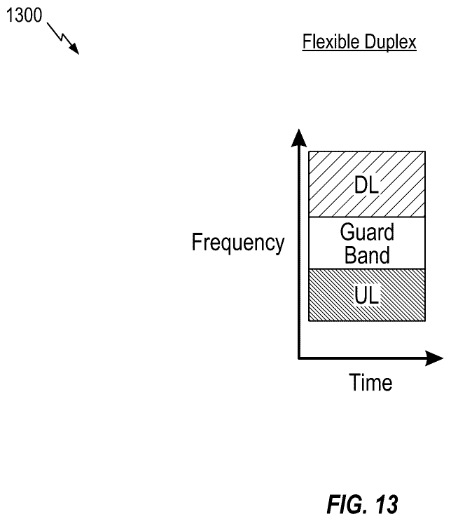

In some cases, a DL resource is separated from an UL resource in a frequency domain. For example, as illustrated in a diagram 1300 of FIG. 13, a lower sub-band (e.g., for the UL) in SBFD slot and an upper sub-band (e.g., for the DL) in the same SBFD slot are separated by a guard band. This slot may be used for simultaneous transmission and reception but on different frequency resources within the slot.

The use of the SBFD slot is advantageous with regard to minimizing or reducing UE-to-UE interference and transmit-to-receive self-interference at a BS. In some cases, the use of the SBFD slot may also enhance system capacity, improve resource utilization and spectrum efficiency (e.g., by enabling flexible and dynamic UL/DL resource adaption according to UL/DL traffic in a robust manner).

### Overview of Channel State Information (CSI)

CSI stands for channel status information. The CSI indicates how good or bad a channel is at a specific time. There are several components of the CSI such as channel quality information (CQI), precoding matrix indicator (PMI), CSI reference signal (RS) resource indicator (CRI), synchronization signal (SS) physical broadcast channel (PBCH) resource block indicator (SSBRI), layer indicator (LI), rank indicator (RI), layer 1 (L1) reference signal receive power (RSRP) etc.

The RI defines a number of possible layers for a downlink transmission under specific channel conditions. The RI also corresponds to a maximum number of uncorrelated paths that the downlink transmission can use.

The PMI consists of a set of indices corresponding to a precoding matrix. The gNB can apply the precoding matrix for a downlink data transmission. The PMI selection is based on a type of a codebook, a number of transmission layers, and other CSI reporting configuration parameters such as antenna panel dimensions. Each codebook consists of a set of precoding matrices. Different codebooks may include type I single-panel codebooks, type I multi-panel codebooks, type II codebooks, and enhanced type II codebooks. For type I single-panel and multi-panel codebooks, a function computes signal to interference plus noise ratio (SINR) at a receiver side for all precoding matrices from a selected codebook and for given channel conditions. Type II codebooks consider a set of orthogonal discrete Fourier transform (DFT) beams to form the precoding matrix.

The CQI is an indicator of channel quality. The CQI value provides information about a highest modulation scheme and a code rate suitable for the downlink transmission to achieve a required block error rate (BLER) for given channel conditions.

All of the components of the CSI may not be measured for every CSI report. Depending on a situation and configuration from a gNodeB (gNB), a user equipment (UE) may perform different measurement combinations of the components for the CSI report.

The UE may use a CSI-RS or any other signal to measure the CSI. The UE sends the CSI to the gNB in the CSI report via a CSI feedback on a physical uplink control channel (PUCCH) or a physical uplink shared channel (PUSSH). Upon receiving the CSI in the CSI report, the gNB may schedule downlink data transmissions (e.g., based on a modulation scheme, a code rate, a number of transmission layers, and multiple input multiple output (MIMO) precoding).

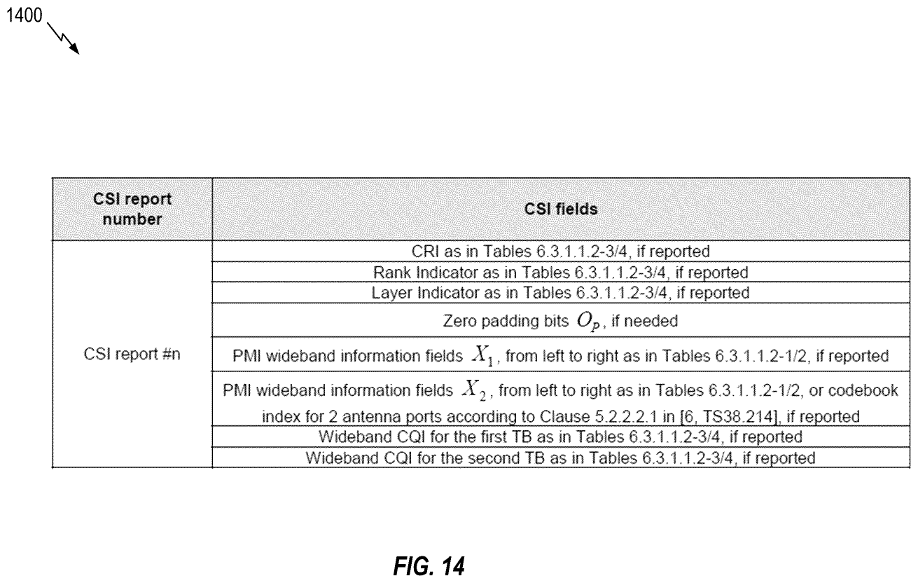

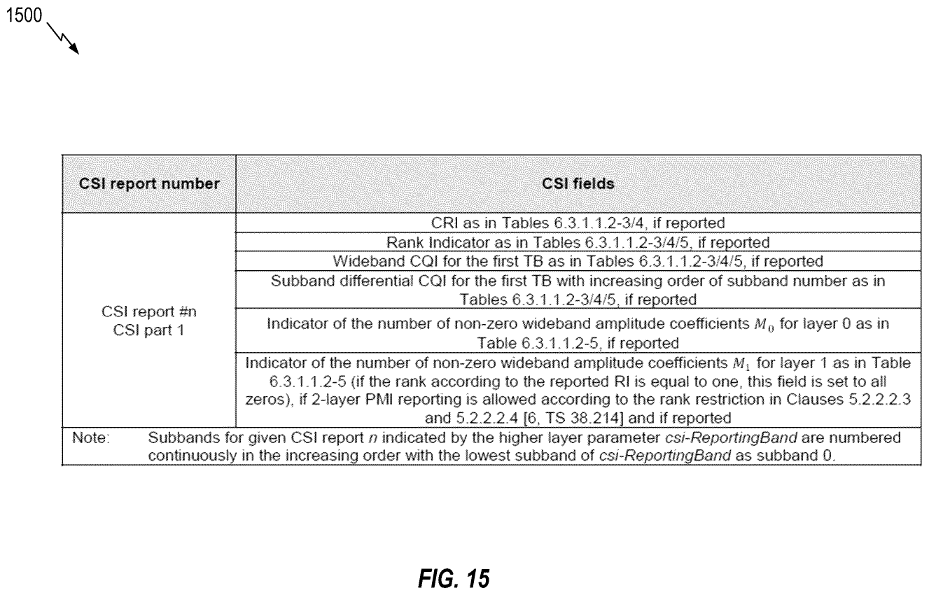

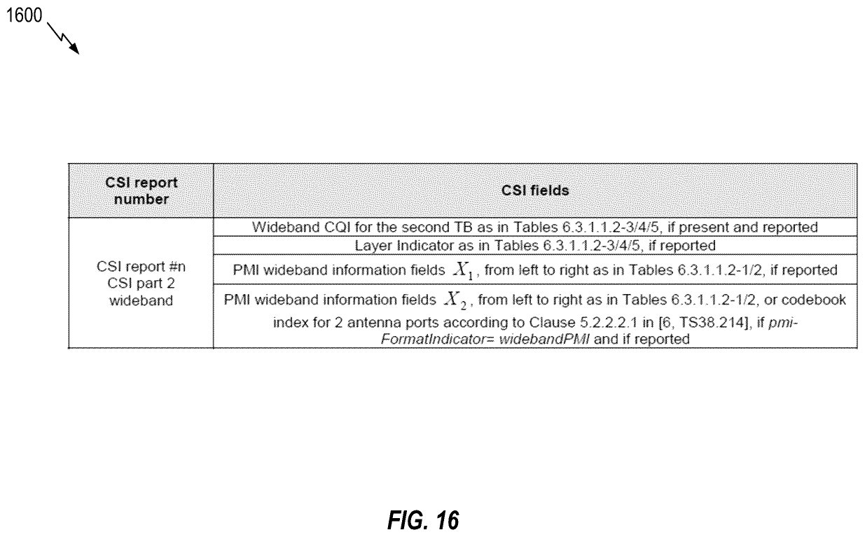

The CSI report may include one or more CSI fields for the CSI. As illustrated in a diagram 1400 of FIG. 14, the CSI fields may include one or more CRI fields for the CRI, one or more RI fields for the RI, one or more LI fields for the LI, one or more CQI fields for a single (wideband) or multiple (subband) CQI, one or more PMI fields for the PMI, and other fields for other components of the CSI. The CSI report may also include one or more padding bits.

The CSI report may include two or more parts (e.g., CSI part 1, CSI part 2). The CSI part 1 (e.g., of the CSI report) has a fixed payload size and is used to identify a number of information bits in the CSI part 2 (e.g., of the CSI report). The CSI part 1 is transmitted before the transmission of the CSI part 2.

In one example, the CSI part 1 may include CSI fields for the RI and an indicator that indicates a size of the CSI part 2. The size of the CSI part 1 may be fixed, whereas the size of the CSI part 2 may vary depending on the RI and some other factors. The CSI part 2 may include CSI fields for wideband and subband PMIs and other channel related information.

In another example (e.g., for type I CSI sub-band reporting on PUCCH formats 3 or 4), the CSI part 1 may include CSI fields (e.g., as illustrated in a diagram 1500 of FIG. 15) for the RI, the CRI, the CQI for a first code word, etc. The CSI part 2 may include CSI fields (e.g., as illustrated in a diagram 1600 of FIG. 16 or as illustrated in a diagram 1700 of FIG. 17) for the PMI, the L1, the CQI for a second code word, a subband different CQI, etc.

### Overview of Cross-Link Interference (CLI)

A wireless communications system may employ time division duplexed (TDD) communications, where a wireless channel is used for both uplink (UL) transmissions and downlink (DL) transmissions.

In a TDD system with macro cells which provide a wide coverage area, the macro cells may use a same TDD UL/DL configuration. For example, the multiple macro cells may use a same slot format which provides, on average, a largest throughput for a large number of users connected to the macro cells.

For small cells (e.g., with a cell radius of a few hundred meters), TDD UL/DL configurations may dynamically change to follow a change of traffic. For example, if the traffic in a small cell shifts toward being more UL-heavy, the TDD UL/DL configuration of the small cell may change to using slots which have more UL symbol periods. The TDD UL/DL configuration of the small cell may be dynamically indicated to user equipments (UEs) in the small cell by, for example, a slot format indicator (SFI) in a downlink control information (DCI). Additionally, or alternatively, the TDD UL/DL configuration of the small cell may be semi-statically configured by a higher layer signaling, such as a radio resource control (RRC) signaling.

In some cases, multiple neighboring cells (e.g., a first cell (cell 1) and a second cell (cell 2)) may use different TDD UL/DL configurations, and this may lead to conflicting symbol periods. For example, a symbol period of the first cell may be configured for DL, where the same symbol period is configured for UL in the second cell. For example, if a first UE associated with the first cell is configured for UL transmission during a symbol period, a second UE associated with the second cell is configured to receive DL transmission during the symbol period, and the first UE and the second UE are in close proximity, the UL transmission of the first UE may cause interference to the reception of the DL transmission at the second UE. This type of interference may be referred to a cross-link interference (CLI). In some cases, differing TDD UL/DL configurations at the multiple neighboring cells may result in UE-to-UE CLI when at least one UL symbol of one cell collides with at least one DL symbol of a nearby cell. The CLI may occur near or between cell edge UEs of the nearby cells.

In some cases, the first UE and the second UE are associated with a same first cell (cell 1). In such cases, the CLI may arise between the first UE and the second UE associated with or within the first cell if a gNodeB (gNB) configures different TDD UL DL slot formats to enable better frequency reuse (e.g., for a full-duplex operation). In some cases, the CLI may arise because the gNB may also need to know a level of the CLI to balance DL capacity loss due to inter-UE interference and capacity enhancement by the frequency reuse.

In some cases, a UE may have a capability to support various types of signal measurements for various types of CLI measurement resources. For example, UE capability parameters may identify a capability to perform a reference signal receive power (RSRP) measurement of a CLI measurement resource, such as a sounding reference signal (SRS) and/or another type of reference signal transmitted by another UE. As another example, the UE capability parameters may identify a capability to perform a received signal strength indicator (RSSI) measurement of a CLI measurement resource, such as a particular time-domain and/or frequency-domain resource.

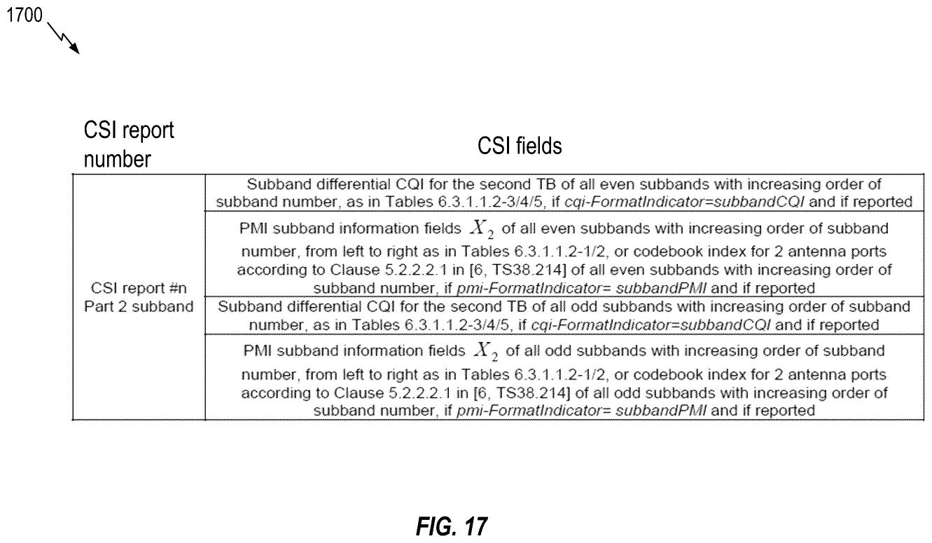

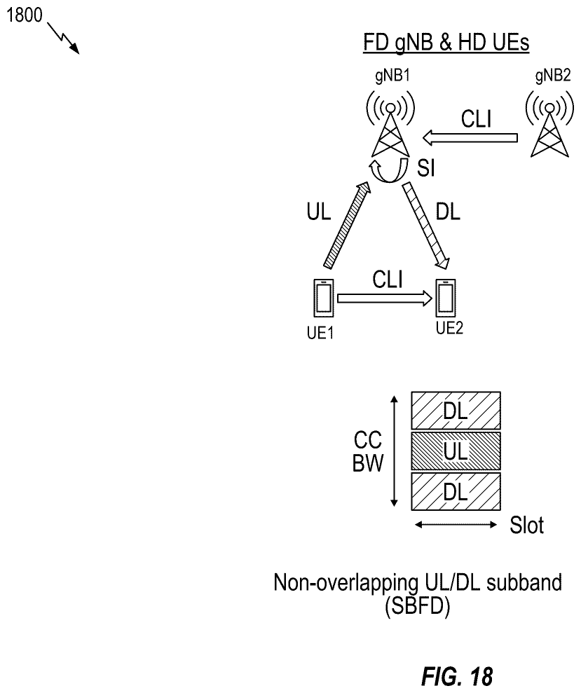

FIG. 18 depicts a diagram 1800 showing communications between a full duplex (FD) gNB and half duplex (HD) UEs. At a first gNB, UL transmissions are received at one antenna panel and DL transmissions are performed from another antenna panel using an SBFD slot. A first UE transmits the UL transmissions and a second UE receives the DL transmissions. The UL transmissions of the first UE may cause an interference (e.g., a CLI) to the reception of the DL transmissions at the second UE. Also, the first gNB may experience the CLI due to transmissions from a second gNB.

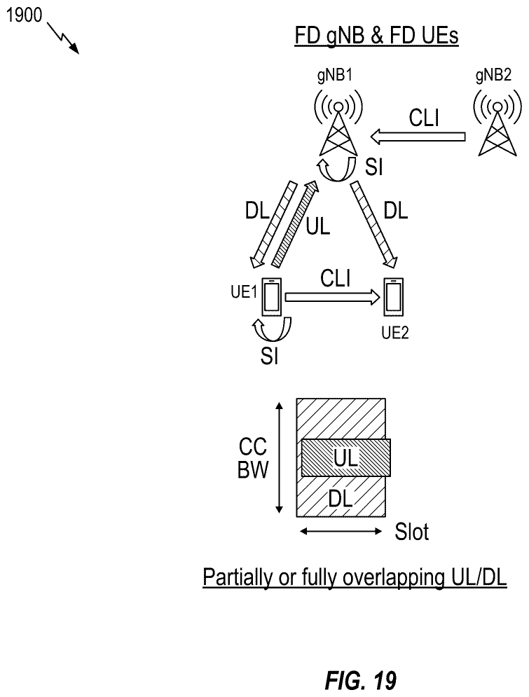

FIG. 19 depicts a diagram 1900 showing communications between FD gNB and FD UEs. At a first gNB, UL transmissions are received at one antenna panel and DL transmissions are performed from another antenna panel using an SBFD slot. At a first UE, the UL transmissions are transmitted from one antenna panel and the DL transmissions are received at another antenna panel. A second UE receives the DL transmissions. The UL transmissions of the first UE may cause an interference (e.g., a CLI) to the reception of the DL transmissions at the second UE. Also, the first gNB may experience the CLI due to transmissions from a second gNB.

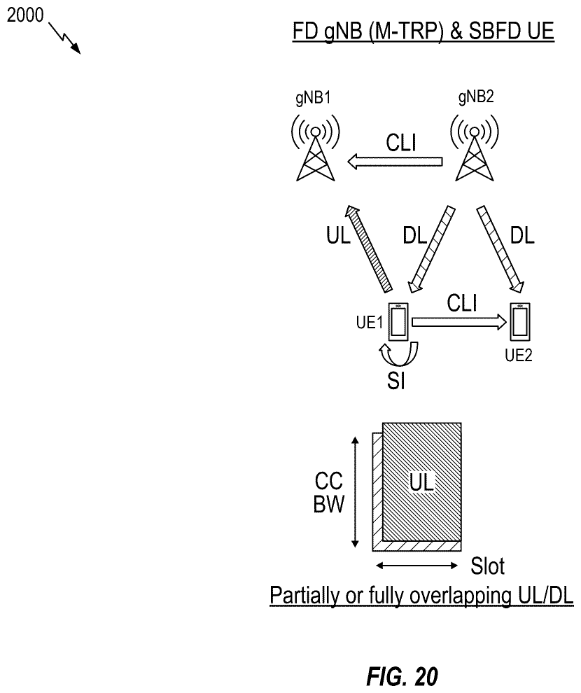

FIG. 20 depicts a diagram 2000 showing communications between FD gNB and a sub-band full duplex (SBFD) UE. At a second gNB, DL transmissions are performed from different antenna panels using an SBFD slot. One downlink transmission is sent to a first UE and another downlink transmission is sent to a second UE. The first UE sends an uplink transmission to a first gNB. At least one UE and at least one gNB may experience an interference (e.g., a CLI) due to transmissions from other UE and other gNB.

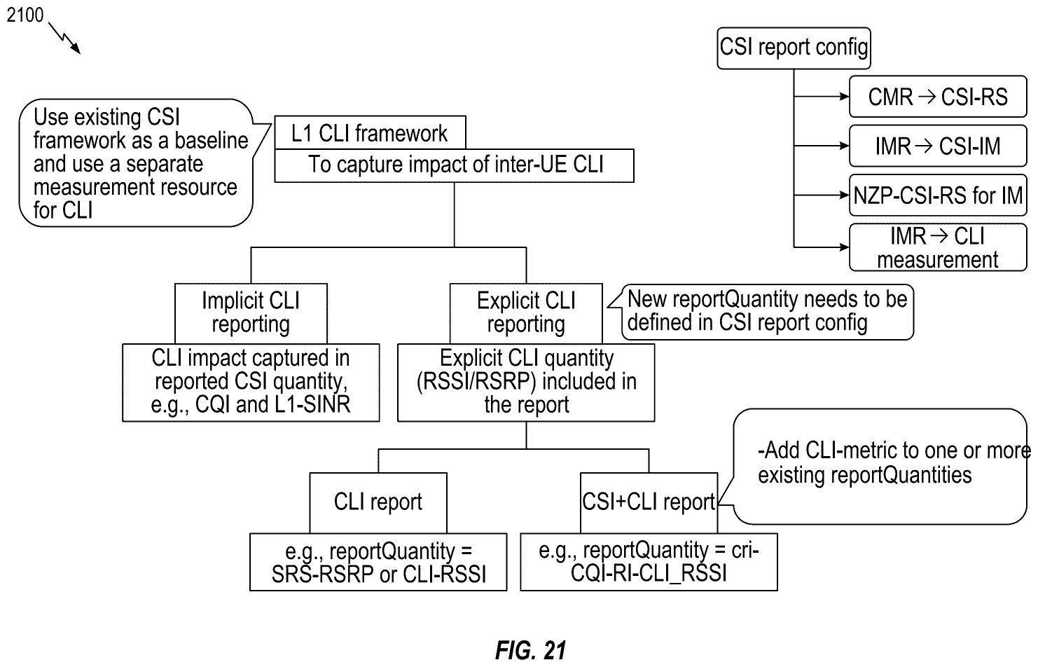

FIG. 21 depicts a diagram 2100 showing a layer 1 (L1) CLI framework for reporting CLI. The L1 CLI framework may use an existing (or legacy) channel state information (CSI) framework as a baseline and use a separate measurement resource for the CLI. In some cases, for reporting of the CLI to a gNB, a UE may add CLI measurements or metrics in a legacy CSI report (e.g., as described in FIGS. 14-17). However, this may require new CSI report payload designs to accommodate both the CLI measurements and CSI.

### Aspects Related to Payload Design for Joint CSI and CLI Reporting On PUSCH and PUCCH in SBFD

Aspects of the present disclosure provide apparatuses, methods, processing systems, and computer-readable mediums for defining multiple new channel state information (CSI) report payload designs for joint reporting of CSI and cross-link interference (CLI) information. The multiple new CSI report payload designs may include at least a first CSI report payload design and a second CSI report payload design.

The first CSI report payload design may be used for the joint reporting of the CLI information and the CSI in the same report that is transmitted via a physical uplink control channel (PUCCH). The first CSI report payload design is based on a modification of an existing payload design of a legacy CSI report including legacy CSI fields. In one example, the modification may include elimination of one or more legacy CSI fields and addition of one or more CLI fields for the CLI information. In another example, the modification may include reducing a size of the one or more legacy CSI fields and addition of the one or more CLI fields for the CLI information.

The second CSI report payload design may be used for the joint reporting of the CLI information and the CSI in the same report that is transmitted via a physical uplink shared channel (PUSCH). The second CSI report payload design may also be based on the modification of the existing payload design of the legacy CSI report including the legacy CSI fields. For example, the modification may include addition of the one or more CLI fields for the CLI information in the legacy CSI report.

Particular aspects of the subject matter described in this disclosure can be implemented to realize one or more of the following potential advantages. In some examples, the described techniques may facilitate improved signal quality and reduced interference.

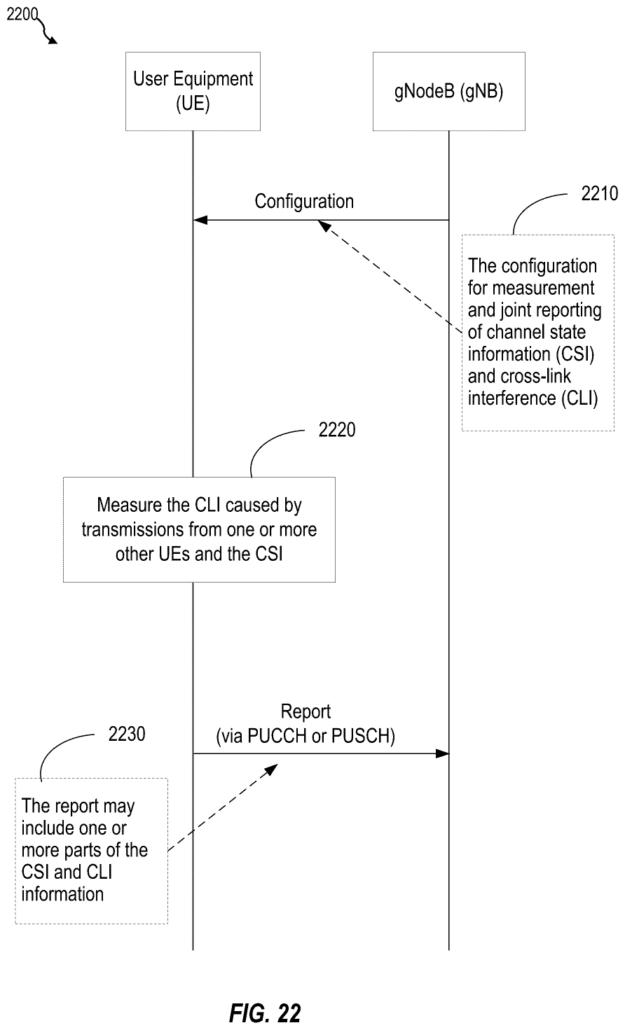

The techniques proposed herein for defining the new report payload design for the joint reporting of the CSI and the CLI information may be understood with reference to FIG. 22-FIG. 24.

FIG. 22 depicts a call flow diagram 2200 illustrating example communication among wireless nodes (e.g., a user equipment (UE), a gNodeB (gNB)) for reporting of CSI and CLI information in a single report. The UE shown in FIG. 22 may be an example of the UE 104 depicted and described with respect to FIG. 1 and FIG. 3. The gNB depicted in FIG. 22 may be an example of the BS 102 depicted and described with respect to FIG. 1 and FIG. 3, or the disaggregated BS depicted and described with respect to FIG. 2.

As indicated at 2210, the gNB sends a configuration to the UE. The configuration configures the UE for measurement and joint reporting of the CSI and the CLI information.

As indicated at 2220, the UE measures CLI caused by transmissions from one or more other UEs. The CLI may indicate a level of interference caused by the other UEs. The UE measures the CSI based on one or more reference signals received by the UE.

In certain aspects, the UE measures the CSI based on interference components measured in CSI interference measurement (IM) (CSI-IM) resources in downlink bandwidth part (BWP) resources. For example, the UE may measure at least one interference component (e.g., received signal strength indicator (RSSI)) in the CSI-IM resources based on uplink reference signals that an aggressor UE. The interference components may include an intra-cell CLI from an interfering uplink signal from the aggressor UE and/or a self-interference from an uplink signal of the UE.

As indicated at 2230, the UE transmits a CSI-CLI report (e.g., a new report with a new set of fields) including one or more parts of the CSI and the CLI information (e.g., the measured CLI). The new report may be different from a legacy CSI report (e.g., as described in FIGS. 14-17) such that at least some of new fields in the new report may be different from at least some of legacy CSI fields in the legacy CSI report. For example, the new report may include some of the legacy CSI fields of the legacy CSI report and the new fields (e.g., such as CLI fields for the CLI information). This may allow the new report to include both the one or more parts of the CSI and the CLI information.

In certain aspects, the UE may transmit the new report with the new fields, which may include one part of CSI (e.g., CSI part 1 or CSI part 2) and the CLI information via a PUCCH. For example, a new report payload structure may be defined and used for joint reporting of the CSI and the CLI information. The new report payload structure may be applicable for at least a single transmission reception point (sTRP) CSI. A maximum payload size of the new report payload structure may be limited to allow for joint reporting of the CSI and the CLI information (e.g., via the PUCCH associated with a PUCCH format 2). An order of the new fields in the new report may different than the order of the legacy CSI fields in the legacy CSI report.

In certain aspects, the UE may eliminate one or more fields in the legacy CSI fields of the legacy CSI report to create the new report with a reduced number of the legacy CSI fields (e.g., which may provide some additional space to include the CLI information). So, a number of the legacy CSI fields in the new report may be less than a number of the legacy CSI fields in the legacy CSI report. The new report may only include some of the legacy CSI fields and some new fields (e.g., for the CLI information). For example, for the sTRP CSI, a legacy CSI field for a second transport block (TB) channel quality indicator (CQI) may not be included in the new report. In another example, a legacy CSI field for a layer indication may not be included in the new report.

In certain aspects, a quantity of all fields (e.g., including the new fields and some of the legacy CSI fields) in the new report may be equal to a quantity of the legacy CSI fields in the legacy CSI report (e.g., the UE may keep all of the legacy CSI fields in the new report but may limit the maximum size of the legacy CSI fields). For example, the UE may limit the use of the new report for certain type I codebook configurations (e.g., N1, N2, ports P) and/or for a number of CSI reference signal (RS) resources in a CSI-RS resource indicator (CRI). N1, N2 are determined by a number of antenna in horizontal and vertical direction.

In certain aspects, the quantity of all fields (e.g., including the new fields and some of the legacy CSI fields) in the new report may be less than the quantity of the legacy CSI fields in the legacy CSI report.

In certain aspects, the UE may replace one or more fields within the legacy CSI fields of the legacy CSI report with the new fields. So, the new report may include some legacy CSI fields and the new fields (e.g., which may have replaced other legacy CSI fields). For example, the UE may re-use a legacy CSI report payload structure (e.g., for joint transmission of the CSI and the CLI information) and only replace some legacy CSI fields of the legacy CSI report with the new fields (e.g., which may be used to include the CLI information). An order of all fields in the new report may be same as the order of the legacy CSI fields in the legacy CSI report (e.g., since only some of the legacy CSI fields are replaced with the new fields in the new report).

In certain aspects, the UE may transmit the new report (e.g., which may include the one or more parts of the CSI and the CLI information) via the PUCCH associated with a PUCCH format 3.

In certain aspects, the UE may transmit the new report (e.g., which may include the one or more parts of the CSI and the CLI information) via the PUCCH associated with a PUCCH format 4.

In certain aspects, the UE may transmit the new report with the new fields (e.g., which may include a first part of CSI (e.g., the CSI part 1), a second part of CSI (e.g., the CSI part 2), and the CLI information) via the PUCCH. The new fields in the new report may include a first subset of fields for the CSI part 1 and a second subset of fields for the CSI part 2.

In certain aspects, the new report may include a new CSI part 1 report (e.g., which may be same or different from a legacy CSI part 1 report) and a new CSI part 2 report (e.g., which may be same or different from a legacy CSI part 2 report).

In certain aspects, the new report may include the new CSI part 1 report (e.g., which may be different from the legacy CSI part 1 report) and the new CSI part 2 report (e.g., which may be same as the legacy CSI part 2 report). For example, a new payload structure may be defined for the new CSI part 1 report (e.g., which may be different from the legacy CSI part 1 report), while the new CSI part 2 report may be kept same as the legacy CSI part 2 report (i.e., all fields in the new CSI part 2 report may be same as all fields in the legacy CSI part 2 report). The new CSI part 1 report may include some new fields for including wideband CLI information.

In certain aspects, the UE may replace some legacy CSI part 1 fields in the legacy CSI part 1 report with the new fields such as the CLI fields. So, the new CSI part 1 report may include the CLI fields and some legacy CSI part 1 fields. The new CSI part 1 report may carry both the CLI information (e.g., in the CLI fields) and the CSI part 1 (e.g., in some of the legacy CSI part 1 fields). For example, a CLI field may replace a type II codebook field of the legacy CSI part 1 report (e.g., reporting of type II codebook part 1 information on the PUCCH may not be supported during the joint reporting of the CSI and the CLI information in a sub-band full duplex (SBFD)). In another example, the CLI field may replace a CRI field of the legacy CSI part 1 report (e.g., only one CSI resource may be configured by a resource set for the joint CSI and CLI information reporting in the SBFD).

In certain aspects, the UE may determine whether to replace some legacy CSI part 1 fields in the legacy CSI part 1 report with the new fields based on capability information associated with the UE. For example, the CLI field may replace the type II codebook field in the legacy CSI part 1 report based on the capability information associated with the UE. In another example, when the UE supports reporting of type II codebook CSI on the PUCCH, then the CRI field in the legacy CSI part 1 report may be replaced with the CLI field. Otherwise, type codebook II fields in the legacy CSI part 1 report may be replaced by one or more CLI fields.

In certain aspects, the new report may include the new CSI part 1 report (e.g., which may be same as the legacy CSI part 1 report) and the new CSI part 2 report (e.g., which may be different from the legacy CSI part 2 report). For example, a new payload structure may be defined for the new CSI part 2 report (e.g., which may be different from the legacy CSI part 2 report), while the new CSI part 1 report may be kept same as the legacy CSI part 1 report (i.e., all fields in the new CSI part 1 report may be same as all fields in the legacy CSI part 1 report). This new payload structure for the new CSI part 2 report is applicable for both wideband and subband precoding matrix indicator (PMI).

In certain aspects, the UE may add one or more additional fields at end of legacy CSI part 2 fields in the legacy CSI part 2 report. So, the new CSI part 2 report may include the legacy CSI part 2 fields and the additional fields (e.g., such as the CLI fields for the CLI information). The CLI information may include the wideband CLI information, even-subband CLI information, and/or odd-subband CLI information.

In certain aspects, the UE may define the one or more additional fields in the new CSI part 2 report to align with a general way of organizing fields in the legacy CSI part 2 report. For example, the one or more additional fields in the new CSI part 2 report may be defined to first include the wideband CLI information, then the even-subband CLI information, and lastly the odd-subband CLI information.

In certain aspects, the UE may replace some legacy CSI part 2 fields in the legacy CSI part 2 report with the new fields. So, the new CSI part 2 report may include the new fields (e.g., such as the CLI fields, which may replace some legacy CSI part 2 fields) and other legacy CSI part 2 fields. For example, the legacy CSI part 2 fields such as one or more CQI code word 2 (CW2) fields may be replaced with one or more CLI fields, which may accommodate the CLI information such as the wideband CLI information, the even-subband CLI information, and/or the odd-subband CLI information.

In certain aspects, the new report may include the new CSI part 1 report (e.g., which may be different from the legacy CSI part 1 report) and the new CSI part 2 report (e.g., which may be different from the legacy CSI part 2 report). For example, a new payload structure may be defined for the new CSI part 1 report (e.g., which may include some new fields that are different from fields in the legacy CSI part 1 report) and for the new CSI part 2 report (e.g., which may include some new fields that are different from fields in the legacy CSI part 2 report). The new fields in the new CSI part 1 report may include the wideband CLI information and the new fields in the new CSI part 2 report may include a sub band differential CLI information.

In certain aspects, the UE may transmit the new report with the new fields (e.g., which may include the CSI part 1, the CSI part 2, and/or the CLI information) via a PUSCH. The new fields may include a first subset of fields (e.g., which may be same or different from fields in the legacy CSI part 1 report) for the CSI part 1 and a second subset of fields (e.g., which may be same or different from fields in the legacy CSI part 2 report) for the CSI part 2.

In certain aspects, the new report may include the new CSI part 1 report with the first subset of fields (e.g., which may be same as the fields in the legacy CSI part 1 report) and the new CSI part 2 report with the second subset of fields (e.g., which may be different from the fields in the legacy CSI part 2 report). For example, there may be no impact to the fields in the legacy CSI part 1 report on the PUSCH and the new CSI part 2 report (e.g., which may include some new CLI fields) is used to convey the CLI information. In some cases, when CLI and CSI report quantity is equal to CRI-rank indicator (RI)-CQI, the UE may use a two-part report and the CLI information may be included in part 2 of the two-part report.

In certain aspects, the UE may add one or more new fields for the CLI information in the legacy CSI part 1 report. So, the new CSI part 1 report may include the legacy CSI part 1 fields and the new fields (e.g., for the CLI information). This may allow the UE to only use the legacy CSI part 1 report for including the CLI information (e.g., when a CLI and CSI report quantity is equal to the CRI-RI-CQI). For example, the UE may define and include wideband CLI fields in the legacy CSI part 1 report for including wideband CLI information. This may allow the use of one-part report for joint reporting of the CSI and the CLI information (e.g., when the CLI and CSI report quantity is equal to the CRI-RI-CQI). In another example, the UE may define and include the wideband CLI fields and sub band CLI fields in the legacy CSI part 1 report for including the wideband CLI information and sub band CLI information. This may allow the use of the one-part report for joint reporting of the CSI and the CLI information (e.g., when the CLI and CSI report quantity is equal to the CRI-RI-CQI).

In certain aspects, the UE may add one or more new fields for the CLI information in the legacy CSI part 2 report. In one aspect, all new fields may be defined and added after the legacy CSI part 2 fields in the legacy CSI part 2 report. For example, the UE may define a new group 3 field for the CLI information in case of “typeII-r16 codebook” and “typeII-r17 codebook”. In another example, the UE may define the new fields after an odd-subband PMI field for wideband and sub band in the legacy CSI part 2 report. In another aspect, the new fields added after the legacy CSI part 2 fields in the legacy CSI part 2 report may have a particular order. For example, the new fields may first include a field for the wideband CLI information, then a field for the even-subband CLI information, lastly a field for the odd-subband CLI information.

In certain aspects, the UE may define a new payload structure for the legacy CSI part 2 report. So, the new CSI part 2 report may include the new fields for the CLI information and some legacy CSI part 2 fields. For example, the new fields may be defined to include the subband CLI information. This new CSI part 2 report may be used when the wideband CLI information may be included in the legacy CSI part 1 report. In another example, the new fields may be defined to include the subband CLI information and the wideband CLI information. This new CSI part 2 report may be used when the wideband CLI information and the subband CLI information may be included in the legacy CSI part 2 report.

### Example Method for Wireless Communications

FIG. 23 shows an example of a method 2300 for wireless communications at a wireless node. The wireless node may be a user equipment (UE), such as the UE 104 of FIG. 1 and FIG. 3.

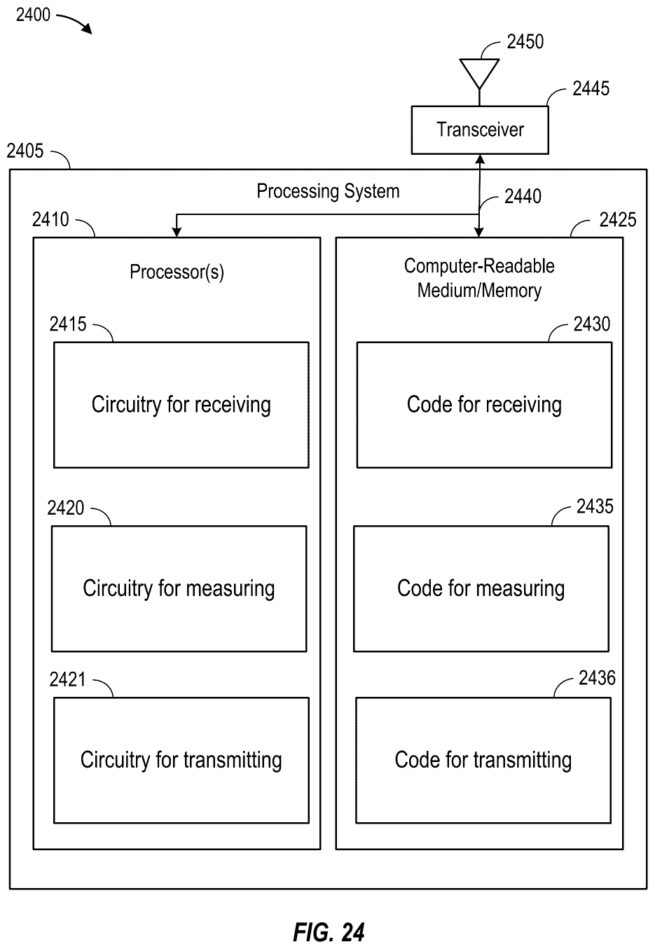

Method 2300 begins at 2310 with receiving a configuration for measurement and joint reporting of channel state information (CSI) and cross-link interference (CLI). In some cases, the operations of this step refer to, or may be performed by, circuitry for receiving and/or code for receiving as described with reference to FIG. 24.

Method 2300 then proceeds to 2320 with measuring the CLI caused by transmissions from one or more other UEs, in accordance with the configuration. In some cases, the operations of this step refer to, or may be performed by, circuitry for measuring and/or code for measuring as described with reference to FIG. 24.

Method 2300 then proceeds to 2330 with transmitting a first report (e.g., a legacy CSI report) with a first set of fields (e.g., legacy CSI report fields) including one or more parts of CSI and CLI information comprising the measured CLI, in accordance with the configuration. In some cases, the operations of this step refer to, or may be performed by, circuitry for transmitting and/or code for transmitting as described with reference to FIG. 24.

In certain aspects, the method 2300 further includes transmitting the first report with the first set of fields including a subset of one part of CSI and the CLI information via a physical uplink control channel (PUCCH).

In certain aspects, a second report includes a second set of fields including the one part of CSI; and the method 2300 further includes eliminating one or more fields from the second set of fields to create the first set of fields.

In certain aspects, a second report includes a second set of fields including the one part of CSI; a quantity of the first set of fields is equal to a quantity of the second set of fields; and a size of each of the first set of fields has a maximum size.

In certain aspects, a second report includes a second set of fields including the one part of CSI; and the method 2300 further includes replacing one or more fields within the second set of fields with one or more new fields to create the first set of fields.

In certain aspects, the first report is transmitted via the PUCCH having a PUCCH format 3 or a PUCCH format 4.

In certain aspects, the method 2300 further includes transmitting the first report with the first set of fields including at least one of: a subset of a first part of CSI, a subset of a second part of CSI or the CLI information via a physical uplink control channel (PUCCH).

In certain aspects, the first set of fields includes a first subset of fields for at least the subset of the first part of CSI and a second subset of fields for at least the subset of the second part of CSI.

In certain aspects, a second report (e.g., a legacy CSI report) includes a second set of fields (e.g., legacy CSI report fields for CSI part 1) including the first part of CSI; and the method 2300 further includes replacing one or more fields within the second set of fields with one or more new fields to create the first subset of fields, wherein the first subset of fields includes the subset of the first part of CSI and the CLI information.

In certain aspects, the method 2300 further includes determining whether to replace the one or more fields within the second set of fields with the one or more new fields based on capability information associated with the UE.

In certain aspects, a second report (e.g., a legacy CSI report) includes a third set of fields (e.g., legacy CSI report fields for CSI part 2) including the second part of CSI; and the method 2300 further includes adding one or more new fields for the CLI information in the third set of fields to create the second subset of fields, wherein the second subset of fields includes the subset of the second part of CSI and the CLI information, and wherein the CLI information includes at least one of: wideband CLI, even-subband CLI, or odd-subband CLI.

In certain aspects, a second report (e.g., a legacy CSI report) includes a third set of fields (e.g., legacy CSI report fields for CSI part 2) including the second part of CSI; and the method 2300 further includes replacing one or more fields within the third set of fields with one or more new fields to create the second subset of fields, wherein the second subset of fields includes the subset of the second part of CSI and the CLI information, and wherein the CLI information includes at least one of: wideband CLI, even-subband CLI, or odd-subband CLI.

In certain aspects, a second report (e.g., a legacy CSI report) includes a second set of fields (e.g., legacy CSI report fields for CSI part 1) including the first part of CSI and a third set of fields (e.g., legacy CSI report fields for CSI part 2) including the second part of CSI; the method 2300 further includes replacing one or more fields within the second set of fields with one or more new fields to create the first subset of fields, wherein the first subset of fields includes the subset of the first part of CSI and the CLI information including wideband CLI; the method 2300 further includes replacing one or more fields within the third set of fields with one or more new fields to create the second subset of fields, wherein the second subset of fields includes the subset of the second part of CSI and the CLI information including at least one of: subband CLI or subband differential CLI.

In certain aspects, the method 2300 further includes transmitting the first report with the first set of fields including: at least one of a subset of a first part of CSI or a subset of a second part of CSI and the CLI information via a physical uplink shared channel (PUSCH).

In certain aspects, the first set of fields includes a first subset of fields for at least the subset of the first part of CSI and a second subset of fields for at least the subset of the second part of CSI.

In certain aspects, the second subset of fields includes the subset of the second part of CSI and the CLI information.

In certain aspects, a second report (e.g., a legacy CSI report) includes a second set of fields (e.g., legacy CSI report fields for CSI part 1) including the first part of CSI; and the method 2300 further includes adding one or more new fields for the CLI information in the second set of fields to create the first subset of fields, wherein the first subset of fields includes the subset of the first part of CSI and the CLI information, and wherein the CLI information includes at least one of: wideband CLI or subband CLI.

In certain aspects, a second report (e.g., a legacy CSI report) includes a third set of fields (e.g., legacy CSI report fields for CSI part 2) including the second part of CSI; and the method 2300 further includes adding one or more new fields for the CLI information in the third set of fields to create the second subset of fields, wherein the second subset of fields includes the subset of the second part of CSI and the CLI information, and wherein the CLI information includes at least one of: wideband CLI, even-subband CLI, or odd-subband CLI.

In certain aspects, the second subset of fields includes: the subset of the second part of CSI and the CLI information comprising subband CLI, or the subset of the second part of CSI and the CLI information comprising subband CLI and wideband CLI.

In one aspect, the method 2300, or any aspect related to it, may be performed by an apparatus, such as a communications device 2400 of FIG. 24, which includes various components operable, configured, or adapted to perform the method 2300. The communications device 2400 is described below in further detail.

Note that FIG. 23 is just one example of a method, and other methods including fewer, additional, or alternative steps are possible consistent with this disclosure.

### Example Communications Device

FIG. 24 depicts aspects of an example communications device 2400. In some aspects, the communications device 2400 may be a user equipment (UE), such as UE 104 described above with respect to FIG. 1 and FIG. 3.

The communications device 2400 includes a processing system 2405 coupled to a transceiver 2445 (e.g., a transmitter and/or a receiver). The transceiver 2445 is configured to transmit and receive signals for the communications device 2400 via an antenna 2450, such as the various signals as described herein. The processing system 2405 may be configured to perform processing functions for the communications device 2400, including processing signals received and/or to be transmitted by the communications device 2400.

The processing system 2405 includes one or more processors 2410. In various aspects, the one or more processors 2410 may be representative of one or more of receive processor 358, transmit processor 364, TX MIMO processor 366, and/or controller/processor 380, as described with respect to FIG. 3. The one or more processors 2410 are coupled to a computer-readable medium/memory 2425 via a bus 2440. In certain aspects, the computer-readable medium/memory 2425 is configured to store instructions (e.g., computer-executable code) that when executed by the one or more processors 2410, cause the one or more processors 2410 to perform the method 2300 described with respect to FIG. 23, and/or any aspect related to it. Note that reference to a processor performing a function of communications device 2400 may include the one or more processors 2410 performing that function of communications device 2400.

In the depicted example, computer-readable medium/memory 2425 stores code (e.g., executable instructions), such as code for receiving (or obtaining) 2430, code for measuring 2435 and code for transmitting (or outputting) 2436. Processing of the code for receiving 2430, the code for measuring 2435 and the code for transmitting 2436 may cause the communications device 2400 to perform the method 2300 described with respect to FIG. 23, and/or any aspect related to it.

The one or more processors 2410 include circuitry configured to implement (e.g., execute) the code stored in the computer-readable medium/memory 2425, including circuitry such as circuitry for receiving (or obtaining) 2415, circuitry for measuring 2424, and circuitry for transmitting (or outputting) 2421. Processing with the circuitry for receiving 2415, the circuitry for measuring 2424, and the circuitry for transmitting 2421 may cause the communications device 2400 to perform the method 2300 described with respect to FIG. 23, and/or any aspect related to it.

Various components of the communications device 2400 may provide means for performing the method 2300 described with respect to FIG. 23, and/or any aspect related to it.

For example, means for transmitting, sending or outputting (e.g., for transmission) may include transceivers 354 and/or antenna(s) 352 of the UE 104 illustrated in FIG. 3 and/or the code for transmitting 2436, the circuitry for transmitting 2421, the transceiver 2445 and the antenna 2450 of the communications device 2400 in FIG. 24. Means for receiving or obtaining may include transceivers 354 and/or antenna(s) 352 of the UE 104 illustrated in FIG. 3 and/or the code for receiving 2430, the circuitry for receiving 2415, the transceiver 2445 and the antenna 2450 of the communications device 2400 in FIG. 24. Means for measuring may include processors, transceivers 354 and/or antenna(s) 352 of the UE 104 illustrated in FIG. 3 and/or the code for measuring 2435, the circuitry for measuring 2424, the transceiver 2445 and the antenna 2450 of the communications device 2400 in FIG. 24.

In some cases, rather than actually transmitting, for example, signals and/or data, a device may have an interface to output signals and/or data for transmission (a means for outputting). For example, a processor may output signals and/or data, via a bus interface, to a radio frequency (RF) front end for transmission. In various aspects, an RF front end may include various components, including transmit and receive processors, transmit and receive MIMO processors, modulators, demodulators, and the like, such as depicted in the examples in FIG. 3.

In some cases, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 3. Notably, FIG. 24 is an example, and many other examples and configurations of communication device 2400 are possible.

### Example Clauses

Implementation examples are described in the following numbered clauses:

Clause 1: A method for wireless communications at a user equipment (UE), comprising: receiving a configuration for measurement and joint reporting of channel state information (CSI) and cross-link interference (CLI); measuring the CLI caused by transmissions from one or more other UEs, in accordance with the configuration; and transmitting a first report with a first set of fields comprising one or more parts of CSI and CLI information comprising the measured CLI, in accordance with the configuration.

Clause 2: The method of clause 1, wherein the transmitting comprises transmitting the first report with the first set of fields comprising a subset of one part of CSI and the CLI information via a physical uplink control channel (PUCCH).

Clause 3: The method of clause 2, wherein: a second report comprises a second set of fields comprising the one part of CSI; and further comprising eliminating one or more fields from the second set of fields to create the first set of fields.

Clause 4: The method of clause 2, wherein: a second report comprises a second set of fields comprising the one part of CSI; a quantity of the first set of fields is equal to a quantity of the second set of fields; and a size of each of the first set of fields has a maximum size.

Clause 5: The method of clause 2, wherein: a second report comprises a second set of fields comprising the one part of CSI; and further comprising replacing one or more fields within the second set of fields with one or more new fields to create the first set of fields.

Clause 6: The method of clause 2, wherein the first report is transmitted via the PUCCH having a PUCCH format 3 or a PUCCH format 4.

Clause 7: The method of any one of clauses 1-6, wherein the transmitting comprises transmitting the first report with the first set of fields comprising at least one of: a subset of a first part of CSI, a subset of a second part of CSI or the CLI information via a physical uplink control channel (PUCCH).

Clause 8: The method of clause 7, wherein the first set of fields comprises a first subset of fields for at least the subset of the first part of CSI and a second subset of fields for at least the subset of the second part of CSI.

Clause 9: The method of clause 8, wherein a second report comprises a second set of fields comprising the first part of CSI; and further comprising replacing one or more fields within the second set of fields with one or more new fields to create the first subset of fields, wherein the first subset of fields comprises the subset of the first part of CSI and the CLI information.

Clause 10: The method of clause 9, further comprising determining whether to replace the one or more fields within the second set of fields with the one or more new fields based on capability information associated with the UE.

Clause 11: The method of clause 8, wherein a second report comprises a third set of fields comprising the second part of CSI; and further comprising adding one or more new fields for the CLI information in the third set of fields to create the second subset of fields, wherein the second subset of fields comprises the subset of the second part of CSI and the CLI information, and wherein the CLI information comprises at least one of: wideband CLI, even-subband CLI, or odd-subband CLI.

Clause 12: The method of clause 8, wherein a second report comprises a third set of fields comprising the second part of CSI; and further comprising replacing one or more fields within the third set of fields with one or more new fields to create the second subset of fields, wherein the second subset of fields comprises the subset of the second part of CSI and the CLI information, and wherein the CLI information comprises at least one of: wideband CLI, even-subband CLI, or odd-subband CLI.

Clause 13: The method of clause 8, wherein a second report comprises a second set of fields comprising the first part of CSI and a third set of fields comprising the second part of CSI; further comprising replacing one or more fields within the second set of fields with one or more new fields to create the first subset of fields, wherein the first subset of fields comprises the subset of the first part of CSI and the CLI information comprising wideband CLI; further comprising replacing one or more fields within the third set of fields with one or more new fields to create the second subset of fields, wherein the second subset of fields comprises the subset of the second part of CSI and the CLI information comprising at least one of: subband CLI or subband differential CLI.

Clause 14: The method of any one of clauses 1-13, wherein the transmitting comprises transmitting the first report with the first set of fields comprising: at least one of a subset of a first part of CSI or a subset of a second part of CSI and the CLI information via a physical uplink shared channel (PUSCH).

Clause 15: The method of clause 14, wherein the first set of fields comprises a first subset of fields for at least the subset of the first part of CSI and a second subset of fields for at least the subset of the second part of CSI.

Clause 16: The method of clause 15, wherein the second subset of fields comprises the subset of the second part of CSI and the CLI information.

Clause 17: The method of clause 15, wherein: a second report comprises a second set of fields comprising the first part of CSI; and further comprising adding one or more new fields for the CLI information in the second set of fields to create the first subset of fields, wherein the first subset of fields comprises the subset of the first part of CSI and the CLI information, and wherein the CLI information comprises at least one of: wideband CLI or subband CLI.

Clause 18: The method of clause 15, wherein: a second report comprises a third set of fields comprising the second part of CSI; and further comprising adding one or more new fields for the CLI information in the third set of fields to create the second subset of fields, wherein the second subset of fields comprises the subset of the second part of CSI and the CLI information, and wherein the CLI information comprises at least one of: wideband CLI, even-subband CLI, or odd-subband CLI.

Clause 19: The method of clause 15, wherein the second subset of fields comprises: the subset of the second part of CSI and the CLI information comprising subband CLI, or the subset of the second part of CSI and the CLI information comprising subband CLI and wideband CLI.

Clause 20: An apparatus, comprising: a memory comprising instructions; and one or more processors configured, individually or in any combination, to execute the instructions and cause the apparatus to perform a method in accordance with any one of Clauses 1-19.

Clause 21: An apparatus, comprising means for performing a method in accordance with any one of Clauses 1-19.

Clause 22: A non-transitory computer-readable medium comprising executable instructions that, when executed by one or more processors of an apparatus, cause the apparatus to perform a method in accordance with any one of Clauses 1-19.

Clause 23: A computer program product embodied on a computer-readable storage medium comprising code for performing a method in accordance with any one of Clauses 1-19.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, the term wireless node may refer to, for example, a network entity or a UE. In this context, a network entity may be a base station (e.g., a gNB) or a module (e.g., a CU, DU, and/or RU) of a disaggregated base station.

While the present disclosure may describe certain operations as being performed by one type of wireless node, the same or similar operations may also be performed by another type of wireless node. For example, operations performed by a network entity may also (or instead) be performed by a UE. Similarly, operations performed by a UE may also (or instead) be performed by a network entity.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communications at a user equipment (UE), comprising:
at least one memory comprising instructions; and
one or more processors, individually or collectively, configured to execute the instructions and cause the apparatus to:
receive a configuration for measurement and joint reporting of channel state information (CSI) and cross-link interference (CLI);
measure the CLI caused by transmissions from one or more other UEs, in accordance with the configuration; and
transmit a first report with a first set of fields comprising one or more parts of CSI and CLI information comprising the measured CLI, in accordance with the configuration.

2. The apparatus of claim 1, wherein the transmit comprises transmit the first report with the first set of fields comprising a subset of one part of CSI and the CLI information via a physical uplink control channel (PUCCH).

3. The apparatus of claim 2, wherein:
a second report comprises a second set of fields comprising the one part of CSI; and
the one or more processors, individually or collectively, are configured to execute the instructions and cause the apparatus to eliminate one or more fields from the second set of fields to create the first set of fields.

4. The apparatus of claim 2, wherein:
a second report comprises a second set of fields comprising the one part of CSI;
a quantity of the first set of fields is equal to a quantity of the second set of fields; and
a size of each of the first set of fields has a maximum size.

5. The apparatus of claim 2, wherein:
a second report comprises a second set of fields comprising the one part of CSI; and
the one or more processors, individually or collectively, are configured to execute the instructions and cause the apparatus to replace one or more fields within the second set of fields with one or more new fields to create the first set of fields.

6. The apparatus of claim 2, wherein the first report is transmitted via the PUCCH having a PUCCH format 3 or a PUCCH format 4.

7. The apparatus of claim 1, wherein the transmit comprises transmit the first report with the first set of fields comprising at least one of: a subset of a first part of CSI, a subset of a second part of CSI or the CLI information via a physical uplink control channel (PUCCH).

8. The apparatus of claim 7, wherein the first set of fields comprises a first subset of fields for at least the subset of the first part of CSI and a second subset of fields for at least the subset of the second part of CSI.

9. The apparatus of claim 8, wherein a second report comprises a second set of fields comprising the first part of CSI; and
the one or more processors, individually or collectively, are configured to execute the instructions and cause the apparatus to replace one or more fields within the second set of fields with one or more new fields to create the first subset of fields, wherein the first subset of fields comprises the subset of the first part of CSI and the CLI information.

10. The apparatus of claim 9, wherein the one or more processors, individually or collectively, are configured to execute the instructions and cause the apparatus to determine whether to replace the one or more fields within the second set of fields with the one or more new fields based on capability information associated with the UE.

11. The apparatus of claim 8, wherein:
a second report comprises a third set of fields comprising the second part of CSI; and
the one or more processors, individually or collectively, are configured to execute the instructions and cause the apparatus to add one or more new fields for the CLI information in the third set of fields to create the second subset of fields, wherein the second subset of fields comprises the subset of the second part of CSI and the CLI information, and wherein the CLI information comprises at least one of: wideband CLI, even-subband CLI, or odd-subband CLI.

12. The apparatus of claim 8, wherein:
a second report comprises a third set of fields comprising the second part of CSI; and
the one or more processors, individually or collectively, are configured to execute the instructions and cause the apparatus to replace one or more fields within the third set of fields with one or more new fields to create the second subset of fields, wherein the second subset of fields comprises the subset of the second part of CSI and the CLI information, and wherein the CLI information comprises at least one of: wideband CLI, even-subband CLI, or odd-subband CLI.

13. The apparatus of claim 8, wherein:
a second report comprises a second set of fields comprising the first part of CSI and a third set of fields comprising the second part of CSI; and
the one or more processors, individually or collectively, are configured to execute the instructions and cause the apparatus to:
replace one or more fields within the second set of fields with one or more new fields to create the first subset of fields, wherein the first subset of fields comprises the subset of the first part of CSI and the CLI information comprising wideband CLI; and
replace one or more fields within the third set of fields with one or more new fields to create the second subset of fields, wherein the second subset of fields comprises the subset of the second part of CSI and the CLI information comprising at least one of: subband CLI or subband differential CLI.

14. The apparatus of claim 1, wherein the transmit comprises transmit the first report with the first set of fields comprising: at least one of a subset of a first part of CSI or a subset of a second part of CSI and the CLI information via a physical uplink shared channel (PUSCH).

15. The apparatus of claim 14, wherein the first set of fields comprises a first subset of fields for at least the subset of the first part of CSI and a second subset of fields for at least the subset of the second part of CSI.

16. The apparatus of claim 15, wherein the second subset of fields comprises the subset of the second part of CSI and the CLI information.

17. The apparatus of claim 15, wherein:
a second report comprises a second set of fields comprising the first part of CSI; and
the one or more processors, individually or collectively, are configured to execute the instructions and cause the apparatus to add one or more new fields for the CLI information in the second set of fields to create the first subset of fields, wherein the first subset of fields comprises the subset of the first part of CSI and the CLI information, and wherein the CLI information comprises at least one of: wideband CLI or subband CLI.

18. The apparatus of claim 15, wherein:
a second report comprises a third set of fields comprising the second part of CSI; and
the one or more processors, individually or collectively, are configured to execute the instructions and cause the apparatus to add one or more new fields for the CLI information in the third set of fields to create the second subset of fields, wherein the second subset of fields comprises the subset of the second part of CSI and the CLI information, and wherein the CLI information comprises at least one of: wideband CLI, even-subband CLI, or odd-subband CLI.

19. The apparatus of claim 15, wherein the second subset of fields comprises: the subset of the second part of CSI and the CLI information comprising subband CLI, or the subset of the second part of CSI and the CLI information comprising subband CLI and wideband CLI.

20. A method for wireless communications at a user equipment (UE), comprising:
receiving a configuration for measurement and joint reporting of channel state information (CSI) and cross-link interference (CLI);
measuring the CLI caused by transmissions from one or more other UEs, in accordance with the configuration; and
transmitting a first report with a first set of fields comprising one or more parts of CSI and CLI information comprising the measured CLI, in accordance with the configuration.
